(19) United States
(12) Patent Application Publication
(10) Pub. No.: US 2010/0266370 A1
(43) Pub. Date: Oct. 21, 2010

(54) Round Bale Trailer

(75) Inventor: Ross Munro, East Moree (AU)

Correspondence Address: MICHAEL MOLINS;MOLINS & CO., SUITE 5, LEVEL 6, 139 MACQUARIE ST, SYDNEY NSW, 2000, AU

(73) Assignee: BMC Partnership Pty Ltd, East Moree (AU)

(21) Appl. No.: 12/726,298

(22) Filed: Mar. 17, 2010

(30) Foreign Application Priority Data
Apr. 16, 2009 (AU) 2009901611
Nov. 5, 2009 (AU) 2009905389

(51) Int. Cl. A01D 90/00

(52) U.S. Cl. 414/24.5

(57) ABSTRACT

A transport bed for carrying round, over sized bales is provided. The bed features a longitudinal conveyor and one or more compression stations. A compression station can compress a stationary bale that is too wide, to a roadable width.

### FIELD OF THE INVENTION

The invention relates to trailers and more particularly to a trailer for loading an oversize compressible load.

The invention has been developed primarily as a trailer for loading and discharging plastic film wrapped round bails such as cotton bales and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

It is known that cotton harvesting machinery is adapted to form and wrap round bales from harvested cotton and deposit such bales in the field, for collection. Such round bales can be collected by trucks towing trailers. Such trailers have flat beds equipped with multiple chain conveyors for loading the cotton bales. However, recent trends in cotton baling have made it necessary to develop trailers that can load ever larger. Without the ability to alter the shape of the bale, the combination of trailer and loaded bales would be too wide to be roadworthy.

### OBJECT OF THE INVENTION

It is an object of the present invention to overcome or ameliorate at least one of the disadvantages of the prior art, or to provide a useful alternative.

It is an object of the invention in its preferred form to provide a trailer for wrapped, round cotton bales. The trailer has a flat bed, chain conveyor and one or more stations for laterally compressing the bales into a configuration that can be made roadworthy.

### SUMMARY OF THE INVENTION

According to an aspect of the invention there is provided a transport bed for carrying round bales, comprising:
one or more compression stations;
wherein the one or more compression stations include one or more pairs of stabilisers located on opposite side edges of the bed;
each compression station adapted to have a compressed orientation wherein a stationary bale on the bed is laterally compressed and an open orientation wherein the bale is not compressed.

A single compression station is preferably wide enough to handle two or more bales. Each compression station preferably comprises a pair of opposing hydraulically activated stabilisers, each stabiliser comprising a rigid post that is pivoted at its lower end with respect to the bed and a hydraulic cylinder affixed between the bed and the stabiliser.

Each compression station preferably comprises a pair of opposing hydraulically activated stabilisers, each stabiliser comprising a rigid post that is pivoted with respect to the bed and a hydraulic cylinder operatively associated between a pair of opposed stabilisers. The hydraulic cylinder is preferably operatively associated between the pair of opposed stabilisers for moving the opposed stabilisers between a substantially vertical transport position and an open or loading position. The hydraulic cylinder is preferably affixed between the opposed stabilisers. Alternatively, the hydraulic cylinder is preferably affixed to a cable for moving the opposed stabilisers between a substantially vertical transport position and an open or loading position.

Each compression station preferably comprises a hydraulically activated stabiliser, each stabiliser comprising a rigid post that is pivoted with respect to the bed and a hydraulic cylinder operatively associated between the bed and the post. The hydraulic cylinder is preferably operatively associated between the bed and the post for moving the opposed stabilisers between a substantially vertical transport position and an open or loading position. The hydraulic cylinder is preferably affixed above the pivot point of the stabiliser. Alternatively, the hydraulic cylinder is preferably affixed below the pivot point of the stabiliser.

The rigid post is preferably pivoted with respect to the bed by a three link hinge assembly.

Preferably, when carrying round bales, the stabilisers in a substantially vertical transport position have a compressed orientation wherein a stationary bale on the bed is laterally compressed. More preferably, when carrying round bales, the stabilisers in an open or loading position have an open orientation wherein the bale is not compressed.

A stabiliser is preferably associated with a pair of orientation bumpers that facilitate a movement of the bales as they are propelled forward by the conveyors. The orientation bumpers are round, steel pipe located to either side of a stabiliser and set at an angle with respect to bed.

Preferably, at least one stabiliser includes at least one transverse brace being a rigid member that is welded to a post. More preferably, one or both ends of the transverse brace are tapered. A hydraulic ram is preferably pivotally attached to the stabiliser at a point below the transverse brace.

A stabiliser of a compression station preferably comprises a rotating crank to which is attached a rigid upright. The crank preferably has an arm that carries a linkage that allows two or more of the compression station halves along one side to be operated by interconnecting them with rigid rods that extend between station halves causing simultaneous rotation of two or more of the compression station halves. The upright is preferably rotated by a shaft that is inclined with respect to vertical, and the shaft rotated in either direction to engage or disengage with a bale.

Preferably, the flat transport bed is adapted to pivot about a wheel assembly. More preferably, the bed carrying a one or more of longitudinal conveyors extending fore and aft. One or more longitudinal conveyors are preferably chain conveyors.

The bed preferably pivots around a wheel assembly under the influence of gravity. The wheel assembly is preferably adapted to advance a set of jack wheels causing a rear end of the bed to tip.

Preferably the transport bed comprises a crawler with powered tracks usable so as to move an entire vehicle comprising a prime mover and the bed forward and backward. More preferably, the conveyors adapted to propel bales forward and onto the bed when loading and able to discharge bales from a rear end when unloading. Most preferably, the transport bed is carried by a trailer.

Preferably, the transport bed further comprises a pivoting gate mechanism having an opposing pair of swing arms, each supporting one or more rotating bumpers. More preferably, the rotating bumpers are two or more on each swing arm mounted for rotation so that a bale contact point of each bumper conforms to the size and shape of a bale.

Preferably, the transport bed further comprises a guide skirt, being a flexible polymer sheet that extends along a length of one or both edges of the bed. More preferably, the skirt can flex in accordance with a movement of the stabilisers.

According to a further aspect of the invention there is provided a transport trailer for carrying round bales, comprising:
a flat transport bed carrying a one or more of longitudinal conveyors extending fore and aft;
the bed having one or more compression stations, each station comprising at least one pair of stabilisers located on opposite side edges of the bed;
each compression station adapted to have a compressed orientation wherein a stationary bale on the bed is laterally compressed and an open orientation wherein the bale is not compressed;
each stabiliser comprising a rigid upright that is adapted to engage with a bale so as to compress it laterally;
a hydraulic ram a pivotally attached to each stabiliser.

Preferably, the one or more of longitudinal conveyors are chain conveyors, and the trailer has a pivoting gate mechanism with an opposing pair of swing arms, each supporting one or more rotating bumpers.

According to another aspect of the invention there is provided a flat bed trailer having multiple longitudinal chain conveyors. The flat bed of the trailer is adapted pivot and a ground contacting end of the flat bed carries a crawler for propelling the flat bed forwards and backwards. The flat bed of the trailer also comprises one or more compression stations. Each station comprises a stabiliser that is hydraulically activated from a loading position into a transport position. In the transport position, a bale located between the stabilisers is compressed. Each station may optionally comprise orientation bumpers.

In preferred embodiments, each stabiliser in an opposing pair further comprises a transverse support.

In some embodiments, a loading gate is provided. The loading gate comprises a pair of swing arms, each equipped with one or more rollers that rotate about a generally vertical axis. The swing arms move from an open or loading position to a closed or transport position.

### BRIEF DESCRIPTION OF THE DRAWING FIGURES

Embodiments of the invention will now be described, by way of example only, with reference to the accompanying drawings in which:

FIG. 1 is a schematic side elevation of a truck having a trailer constructed in accordance with the teachings of the present invention;

FIG. 2 is a schematic side elevation of the device depicted in FIG. 1 showing the pivoting trailer making ground contact using the crawler;

FIG. 3 is an end elevation showing the compression of a bale once loaded;

FIG. 4 is a perspective view of one half of a compression station;

FIG. 4a is an end elevation of one half of a compression station;

FIG. 5 is an end elevation depicting the loading gate in a transport orientation;

FIG. 6 is an end elevation showing the loading gate in a loading orientation;

FIG. 7 is a perspective view showing how a guide skirt is affixed to a fixed bumper;

FIG. 8 is a top schematic view showing the insulation of the guide skirt;

FIG. 9 is a schematic perspective view of an alternate embodiment of the invention;

FIG. 10 is an end elevation of yet another embodiment of the invention;

FIG. 11A is an end elevation of yet another embodiment of the invention, shown in the closed configuration;

FIG. 11B is an end elevation of the embodiment of FIG. 11A, shown in the open configuration;

FIG. 11C is an end elevation of yet another embodiment of the invention, shown in the closed configuration;

FIG. 11D is an end elevation of the embodiment of FIG. 11B, shown in the open configuration;

FIG. 11E is an end elevation of yet another embodiment of the invention, shown in the closed configuration;

FIG. 11F is an end elevation of the embodiment of FIG. 11E, shown in the open configuration;

FIG. 12A is a side elevation of an example alternative hinge assembly, shown in the closed configuration;

FIG. 12B is a side elevation of the hinge assembly of FIG. 12A, shown in the open configuration;

FIG. 12C is a side elevation of an example alternative compression station hinge assembly, shown in the closed configuration;

FIG. 12D is a side elevation of the hinge assembly of FIG. 12C, shown in the open configuration;

FIG. 12E is a side elevation of an example alternative compression station hinge assembly, shown in the closed configuration;

FIG. 12F is a side elevation of the hinge assembly of FIG. 12E, shown in the open configuration;

FIG. 12G is a side elevation of an example alternative compression station hinge assembly, shown in the closed configuration; and

FIG. 12H is a side elevation of the hinge assembly of FIG. 12G, shown in the open configuration.

### BEST MODE AND OTHER EMBODIMENTS

This specification incorporates, by reference, Australian Application No. 2008207644. It discloses a type of chain conveyor that may be used with the following technology.

This specification incorporates, by reference, Australian Application No. 2009901611 and U.S. application Ser. No. 12/12/485,912. Disclosing trailers, and more particularly to a trailer for loading an oversize compressible load, that may be used with the following technology.

The present description provides teachings relating to the handling of bales of cotton. It will be understood that these teachings apply to bales of other products and that the use of the technology is not limited to cotton bale handling.

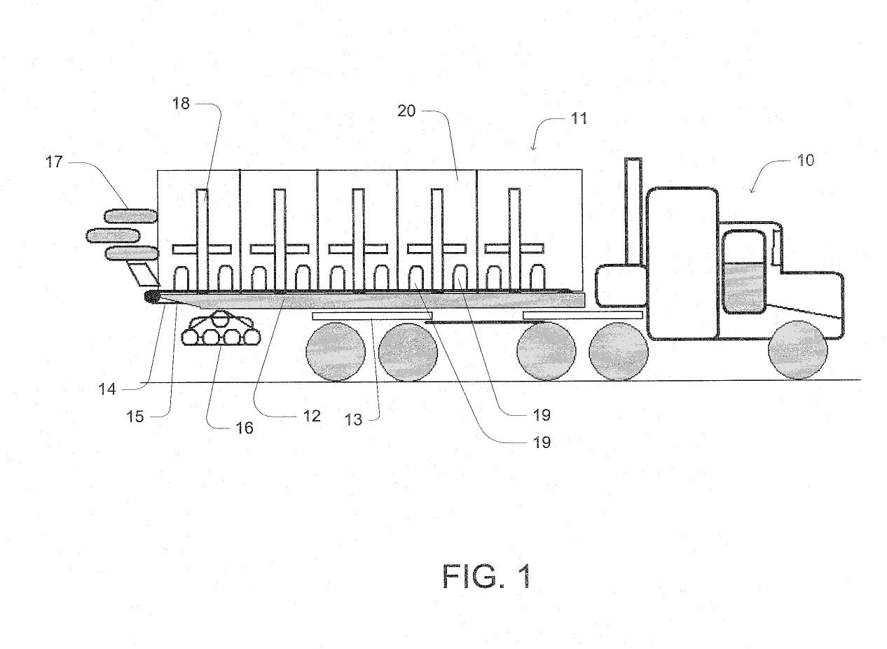

As shown in FIG. 1, a prime mover 10 such as a truck or tractor unit or the like is adapted to carry a flat bed for carrying loads, such as a trailer 11. The trailer 11 comprises a flat transport bed 12 and is adapted to pivot about a wheel assembly or wheel bogie 13. The bed 12 carries a number of longitudinal chain (or other) conveyors 14 as is common practice in trailers used for collecting cotton bales. It will be noted that other forms of continuous conveyor may be used such as rubber belts, articulated plates or the like. The conveyors 14 extend fore and aft from one end of the bed 12 to the other. The rear end 15 of the bed may be tapered to allow the conveyors to be located closer to the ground. A crawler or motorised track module 16 is located below the rear end 15 of the bed. The trailer 11 further comprises a pivoting, loading and transport gate 17 and one or more compression stations 18. Each station 18 comprises a pair hydraulic stabilisers located on opposite side edges of the bed 12. In this example, a pair of orientation bumpers 19 is provided for each stabiliser. The compression stations act to laterally compress a bale, stabilise it for transport over road and reduce the effective width of the bales to comply with applicable road rules.

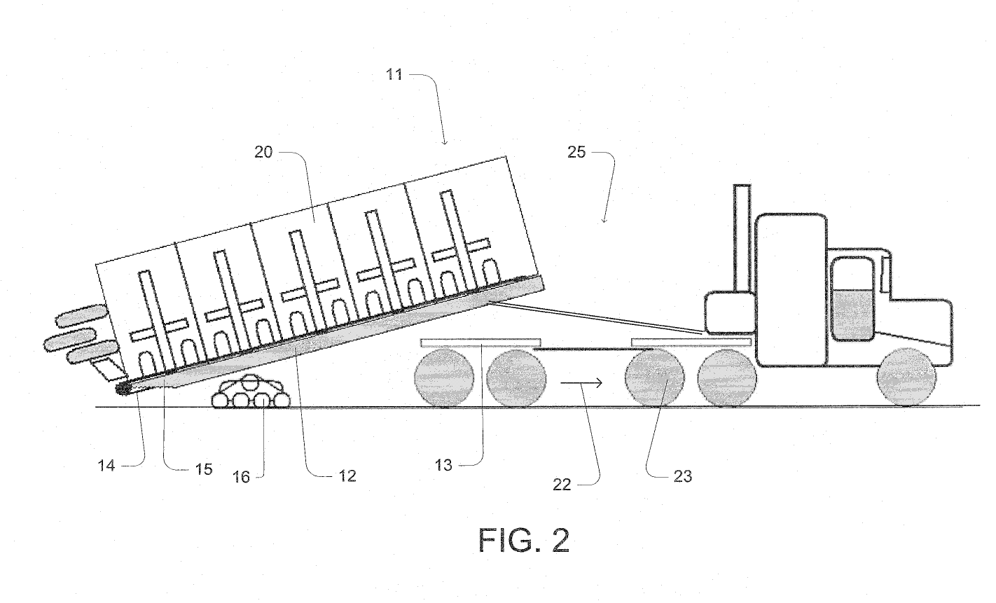

As shown in FIG. 2, the trailer's bed 12 pivots around a two axle wheel assembly 13. The trailer's bed pivots under the influence of gravity as the rear, two axel wheel assembly 13 is caused to advance 22 toward the set of jack wheels 23. This can be done using hydraulic pistons or the like. As the wheel assembly 13 advances 22, the bed 12 becomes out of balance and the rear end 15 of the bed tips toward the ground. In this orientation, the crawler 16 makes ground contact. With the crawler in contact with the ground, its hydraulically powered tracks are activated so that the entire vehicle 25 (including prime mover and trailer) can be moved forward and backward relative to the bales that have been pre-arranged on the ground. As is well known in this aft, the entire vehicle is propelled backwards when collecting bales and propelled forward when discharging bales. The chain conveyors 14 propel bales forward and onto the bed when loading and are able to discharge bales from the rear end 15 when unloading.

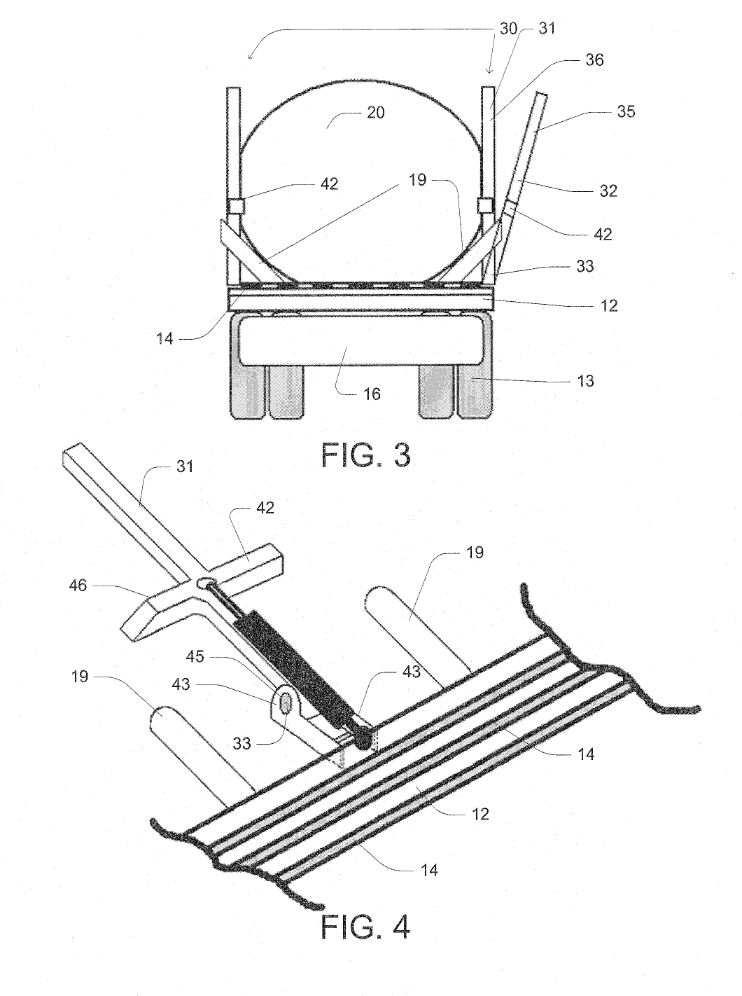

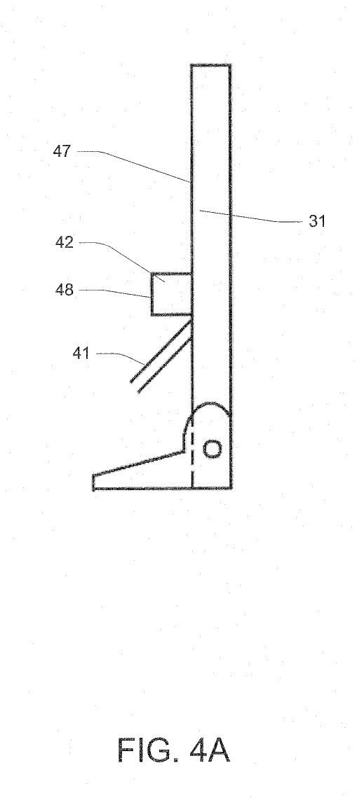

As shown in FIG. 3, each compression station 30 comprises a pair of opposing hydraulically activated stabilisers 31 adapted for lateral compression of one or more bales. For clarity, the pivoting gate 17 is not shown in this view. Stabilisers 31 are located opposite one another along the side edges of the bed 12. As suggested by FIGS. 3 and 4, each stabiliser 31 comprises a rigid upright, post or beam 32 that is pivoted at its lower end 33 with respect to the bed. A hydraulic cylinder (see FIG. 4) 41 is affixed between the bed 12 and the stabiliser 31. Thus, under the influence of the hydraulic cylinder 41, the stabiliser 31 can assume a continuity of positions including an open or loading position 35 and a vertical transport position 36. In the loading position 35 the stabiliser 31 is pivoted outboard of the width of the flat bed 12 and with its opposite stabiliser is adapted to create a gap into which a round bale can easily fit. The orientation bumpers 19 act to facilitate the smooth movement of the bales into position as they are propelled forward by the conveyors 14. The orientation bumpers are round, steel pipe located to either side of a stabiliser 31 and set at a roughly 45 degree angle with respect to bed 12. The bumpers 19 may optionally incorporate a roller mechanism. The bumpers 19 prevent the bale's forward motion from being interfered with by the stabilisers 31. Similarly, the bumpers 19 protect the stabilisers 31 from being impacted by the bales 20. In this example, each stabiliser 31 includes a transverse brace 42. In this example, the transverse brace 42 is a rigid member that is welded to the post 31. The brace 42 distributes the compression stress exerted by the stabiliser across a greater area on the bale than would otherwise occur. Each stabiliser may incorporate one or more braces 42 of any of a variety of shapes and sites. Note that one or both ends of the transverse brace 42 may be tapered 46 to prevent binding and ease the motion of the bale as it passes over the stabiliser.

As shown in FIG. 4, in an example embodiment the post 31 is pivotally supported between a pair of metal side brackets 43. The brackets are carried by the bed 12. Bearings at the pivot point 45 support the stabiliser for rotating motion about its lower end 33. As better shown in FIG. 3, once a bale 20 is loaded between the stabilisers of a compression station 30 the hydraulic ram 41 is shortened to bring a stabiliser 31 into a generally upright or vertical transport orientation. The bale is compressed horizontally so that it fits comfortably within the width of the trailer. In particular, with the stabilisers in the transport position, the bale is narrower than the width of the bed 12 and is the same width as the distance between the stabilisers 31. Without this lateral compression, the bale would be too large to transport on public roads.

In an embodiment, and as shown in FIG. 4a, the transverse brace 42 is preferably welded to the interior surface 47 of the stabiliser 31. This creates a gap between the bale contacting part of the brace 48 and the upright stabiliser 31. This reduces the chances that the bale will bind on the stabiliser 31. This feature also creates additional compression on the bale where it is most useful. Note that the hydraulic ram 41 is pivotally attached to the stabiliser 31 at a point below the transverse brace 42.

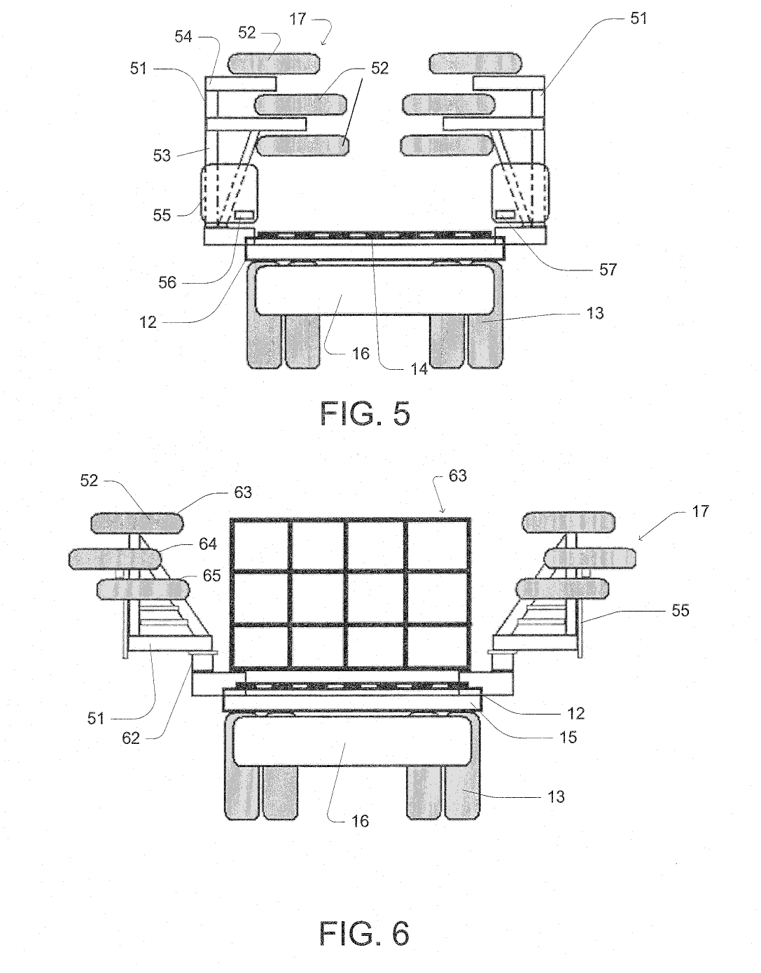

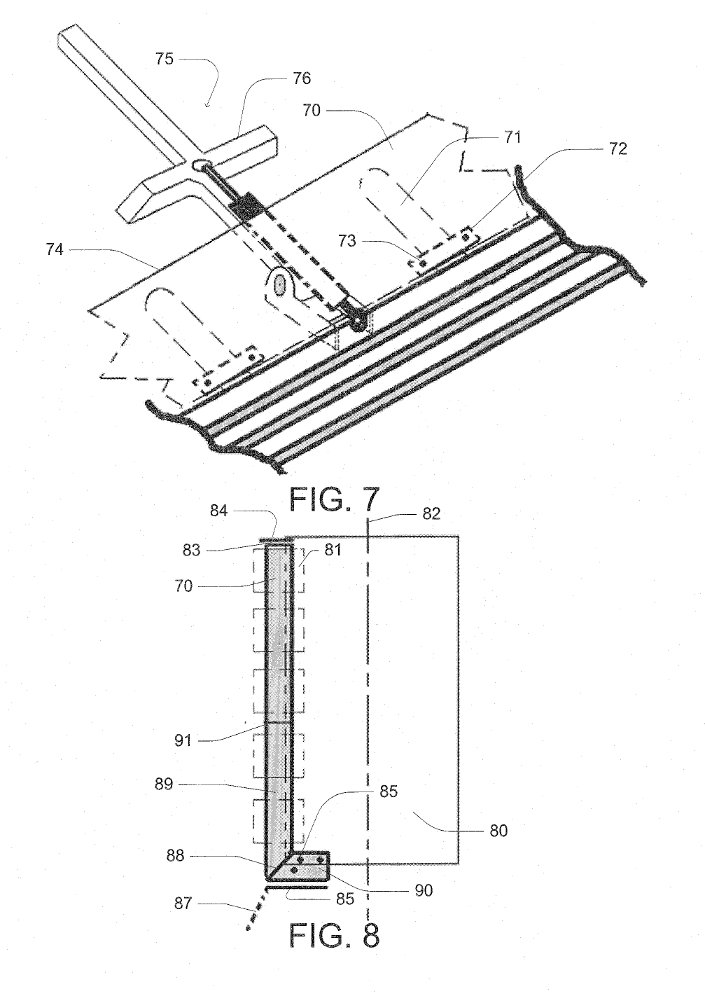

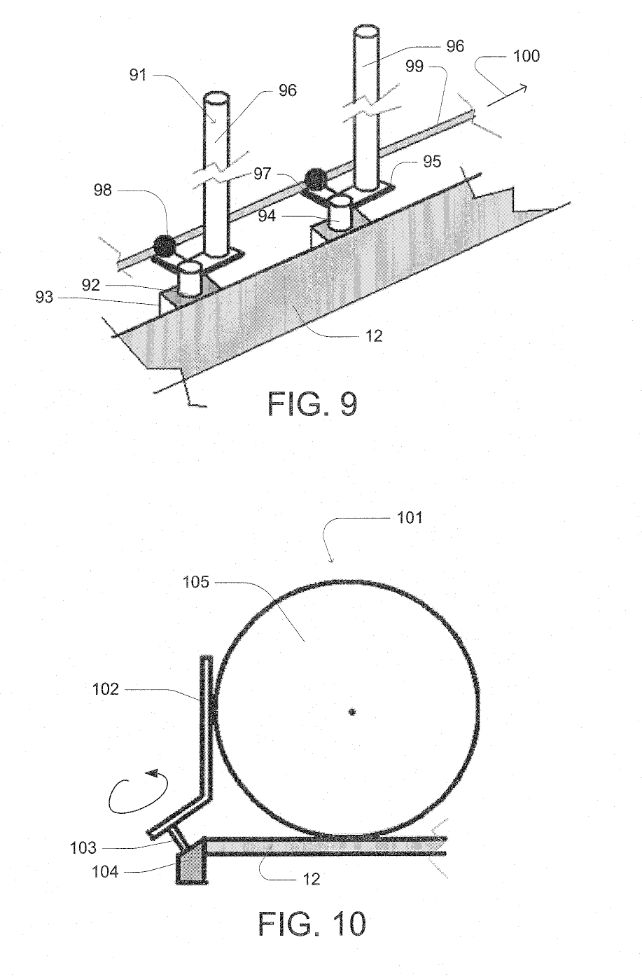

As shown in FIGS. 5 and 6 a transport trailer for round cotton bales is provided with a pivoting gate mechanism 17. The pivoting gate 17 comprises an opposing pair of swing arms 51, each supporting, in this example, three rotating bumpers or pneumatic tires 52. A swing arm 51 comprises a vertical upright 53 and horizontal members 54, as required to support the rotating tires 52. Each pivot arm 53 of the gate is adapted to carry a road sign 55 warning lights and turn signals 56 or a licence plate 57, as required. In FIG. 5, the gate 17 is shown in a closed orientation and ready for transport. In this orientation, tires 52 block the open end of the bed 12 so that the bales 20 cannot be inadvertently discharged.

In FIG. 6, the gate 17 is shown in a loading orientation. In this orientation, the swing arms 51 have been pivoted with their respective hydraulic motors 62 so that the vertically stacked, vertical axis rollers or tires 52 no longer block the rear end 15 of the bed 12. Note that in the elevation view of FIG. 6, the tires 52 are stagger mounted for rotation in a horizontal plain so that the bale contact points of each tire 63, 64, 65, conform to the size and rounded exterior shape of a bale. It will be understood that the gates 17 may be opened and closed while the bed is in the ground contacting orientation depicted in FIG. 2. FIG. 6 also illustrates that the front of the bed 12 may carry a fixed metal frame 63. The frame 63 is as wide as the bed 12 and about as tall as a bale 20 and prevents the bales from moving forward during deceleration of the trailer or, for example, when travelling down hill.

In the above examples, it will be appreciated that the trailer of the present invention has been disclosed as having five independent compression stations. It will be appreciated that the number of compression stations is not material to the invention and that practically any number of compression stations may be utilised on a trailer. In effect, each side may be operated as a single independent compression station. Similarly more than five compression stations per side may be used. It has also been disclosed that a single bale is retained by a single compression station. It will be appreciated that a single compression station may be wide enough to handle two or more bales and that two or more compression stations may be used to retain a single bale.

An optional feature of the present invention is a guide skirt 70. The skirt 70 comprises a heavy but flexible polymer sheet that extends along the length of the edge of the bed of the trailer. As previously explained, the bumpers 71 extend away from the bed at an angle of about 45 degrees. The skirt 70 lies flat across the bumpers. Some or all of the bumpers 71 have a flat rectangular plate 72 welded or otherwise affixed to an upper surface. The plate 72 provides a flat point of attachment for affixing the skirt 70. A pair of smooth headed fasteners 73 is used to attach the skirt 70 to each plate 72. This allows the upper edge 74 of the skirt to flex in accordance with the movement of the stabilisers 75. In this example, the bumpers 71 and stabiliser assembly 75 are shown as located below the skirt 70. Note that the upper edge of the skirt 74 does not reach as high as the cross piece 76. Thus, it cannot interfere with or be interfered with by the cross piece 76.

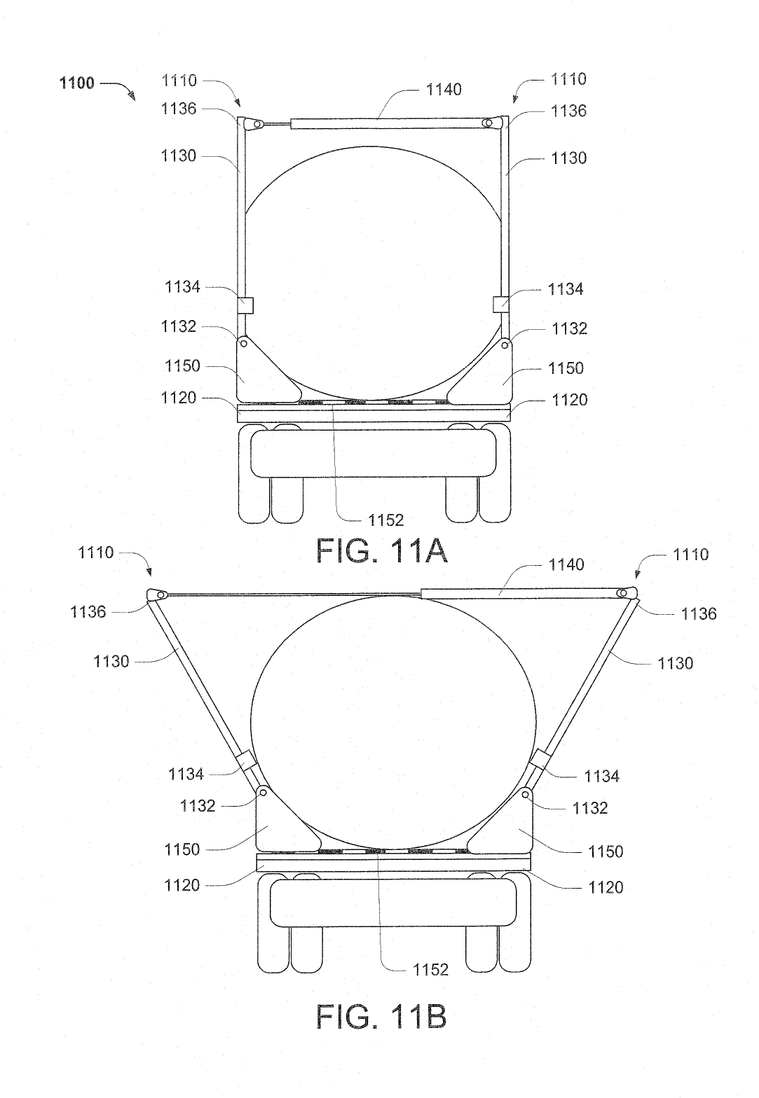

As shown in FIG. 8, the skirt 70 extends substantially the length of the bed 80 of the trailer. The skirt 70 is shown in relation to schematic depictions of the five stabiliser components 81 located on one side of the longitudinal centre line 82 of the trailer. The forward edge 83 of the skirt 70 is affixed to a straight, rigid steel angle 84 that also extends at approximately a 45 degree angle to the bed. In the example of FIG. 8, the skirt also covers the interior face of the pivoting gate mechanism 85. It is affixed at various points 86 to the interior face of the gate mechanism and allows the gate mechanism to move from the closed position to the open position 87. An angled joint 88 between the major length of the skirt 89 and that part covering the gate portion 90 provides adequate flexibility. Because of the length of the major extend 89, individual sections may be joined at a transverse seam 91, by threaded fasteners or the like.

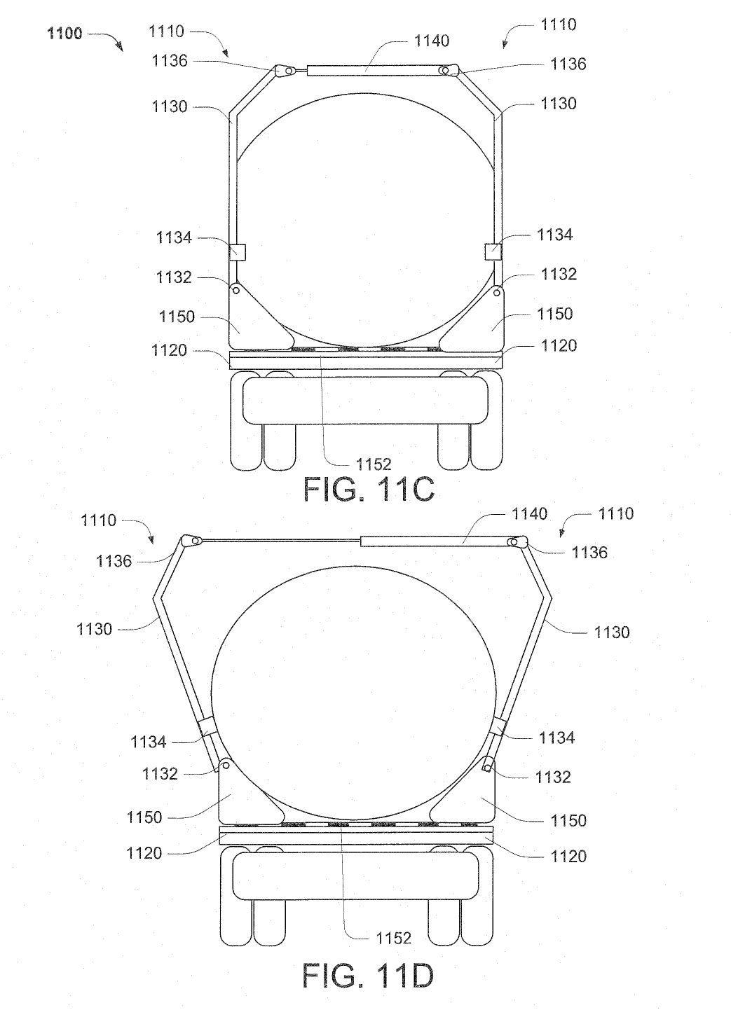

As shown in FIG. 9 compression of the cotton bales may be achieved by a variety of mechanisms in addition to those ones already disclosed. In this example, rotating crank-like compression station halves (rather than pivoting ones) are distributed along the side of the bed 12 in the manner suggested by FIGS. 1 and 4. In accordance with those examples, each compression station half 91 has a corresponding half (not shown) along an opposite edge of bed 12. In the example of FIG. 9, each compression station half 91 comprises a rotating crank 92 that is supported by bearings 93. A rotating stub shaft 94 carries a crank arm 95 to which is attached a rigid upright 96. In this example, the stub shaft 94 also carries a second arm 97 that carries a joint, link, linkage, articulated joint, ball joint or the like 98. This allows all (or some) of the compression station halves 91 along one side to be operated by interconnecting them with rigid rods 99 that extend between station halves. Thus, reciprocation of one end of the assembly of rods and joints 98, 99 causes the rotation of one or more of the compression station halves 91. In the position illustrated, the uprights 96 allow the bales to be loaded. Advancement of the rods 99 in the direction of the arrow 100 causes the uprights to be rotated into a compression position against the loaded bales.

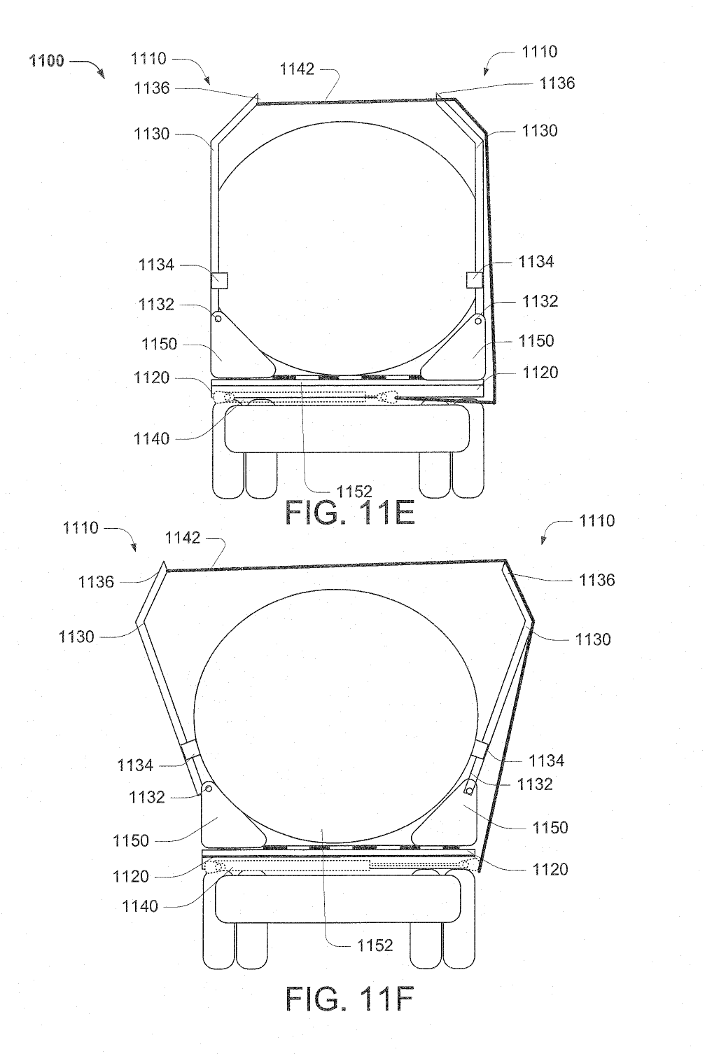

Another embodiment based on crank arm rotation 101 is depicted in FIG. 10. In this example, bent compression station arms 102 are rotated by a shaft 103 that is inclined with respect to vertical. The rotating shafts 103 are carried by hearings or a gear box or hydraulic motor or actuator 104 etc. In the orientation depicted in FIG. 10, the crank-like rotating compression arms 102 are in contact with and act to compress the cotton bale 105. When the shaft 103 is rotated in either direction, the rigid compression arm 102 will cease engagement with the bale 105, thus allowing loaded or unloading. The rigid uprights seen in FIGS. 9 and 10 may have smooth or low friction or independently rotation working surfaces that facilitate the movement of the uprights against the plastic sheet surfaces of the bales.

It will be appreciated that the present invention has been disclosed with reference to particular details of construction, these should be understood as having been provided by way of example and not as limitations to the scope or spirit of the invention.

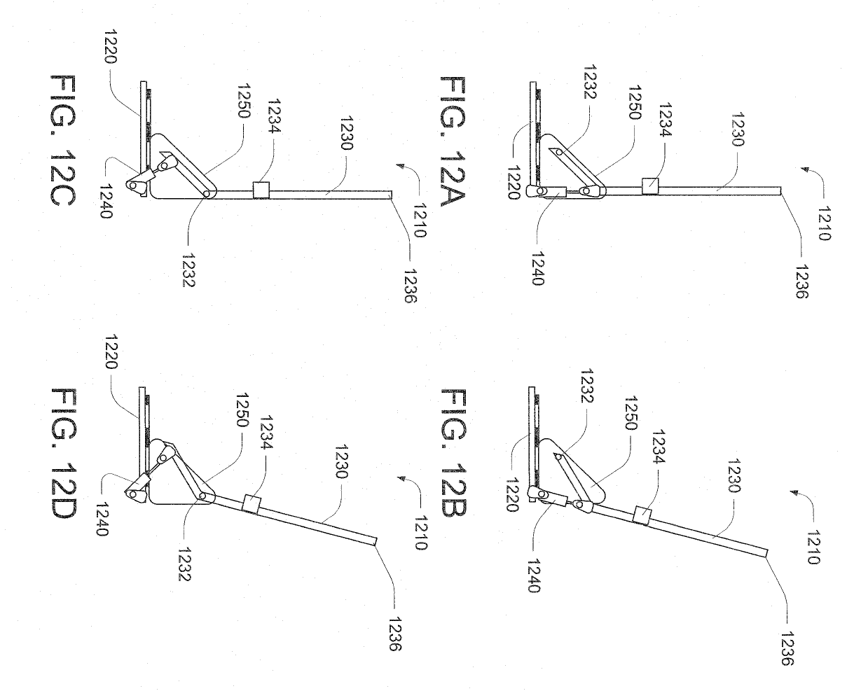

Referring to FIGS. 11A, 11B, 11C, 11D 11E and 11F; in an embodiment, each compression station 1100 can comprise a pair of opposing hydraulically activated stabilisers 1110 adapted for lateral compression of one or more bales. For clarity, a pivoting gate is not shown in this view. Stabilisers 1110 are located opposite one another along the side edges of the bed 1120. Each stabiliser 1110 comprises a rigid upright, post or beam 1130 that is pivoted at its lower end 1132 with respect to the bed. A hydraulic cylinder 1140 is coupled to a pair of poising stabilisers 1110.

Thus, under the influence of the hydraulic cylinder 1140, the stabilisers can assume a continuity of positions including a substantially vertical transport position (as best shown in FIG. 11A) and an open or loading position (as best shown in FIG. 11B). In the loading position the stabiliser 1110 is pivoted outboard of the width of the flat bed 1120 and with its opposite stabiliser is adapted to create a gap into which a round bale can easily fit.

The orientation bumpers 1150 act to facilitate the smooth movement of the bales into position as they are propelled forward by the conveyors 1152. The orientation bumpers set at a roughly 45 degree angle with respect to bed 1120. The bumpers are adapted to prevent the bale's forward motion from being interfered with by the stabilisers 1110. Similarly, the bumpers 1150 protect the stabilisers 1110 from being impacted by the bales 1154 when in the locating position.

In an embodiment, each stabiliser 1110 includes a transverse brace 1134. In this example, the transverse brace 1134 is a rigid member that is welded to the post 1130. The brace 1134 distributes the compression stress exerted by the stabiliser across a greater area on the bale than would otherwise occur. Each stabiliser may incorporate one or more braces 1134 of any of a variety of shapes and sites. Note that one or both ends of the transverse brace 1132 may be tapered to prevent binding and ease the motion of the bale as it passes over the stabiliser.

As shown in FIG. 11A and FIG. 11B, the hydraulic cylinder 1140 is attached to the upper end 1136 of the post 1130 of opposing stabilisers. Extension and retraction of the hydraulic cylinder moves the stabilisers between a substantially vertical transport position (as best shown in FIG. 11A) and an open or loading position (as best shown in FIG. 11B).

As shown in FIG. 11C and FIG. 11D, the hydraulic cylinder 1140 is attached to the upper end 1136 of the post 1130 of opposing stabilisers. Extension and retraction of the hydraulic cylinder moves the stabilisers between a substantially vertical transport position (as best shown in FIG. 11C) and an open or loading position (as best shown in FIG. 11D). It will be appreciated that, by inwardly bending a top portion of each of the opposed stabiliser posts 1130, the height of the stabiliser post in the open or loading position (as best shown in FIG. 11D) can be extended when compared with the configuration of FIG. 11B, and thereby require a smaller hydraulic cylinder.

As shown in FIG. 11E and FIG. 11F, a cable 1142 can be applied between the upper end 1136 of the post 1130 of opposing stabilisers. The cable is fastened to one post, wherein the other end of the cable is coupled to a hydraulic cylinder 1140 and movably coupled about the other post. Extension and retraction of the hydraulic cylinder relaxes and tensions the cable to thereby moves the stabilisers between a substantially vertical transport position (as best shown in FIG. 11E) and an open or loading position (as best shown in FIG. 11F). The hydraulic ram 1140 can be located below the bed. Alternatively a motor or winch could be used to relax and tension the cable.

The bale is compressed horizontally so that it fits comfortably within the width of the trailer. In particular, with the stabilisers in the transport position, the bale is narrower than the width of the bed 1120 and is the same width as the distance between the stabilisers 1110. Without this lateral compression, the bale would be too large to transport on public roads.

It will be appreciated that alternative hinge (or pivot) assemblies can be used for hingedly connecting a stabiliser 1110 to the bed 1120 and/or for application of torque to the post 1230 of a stabiliser 1110.

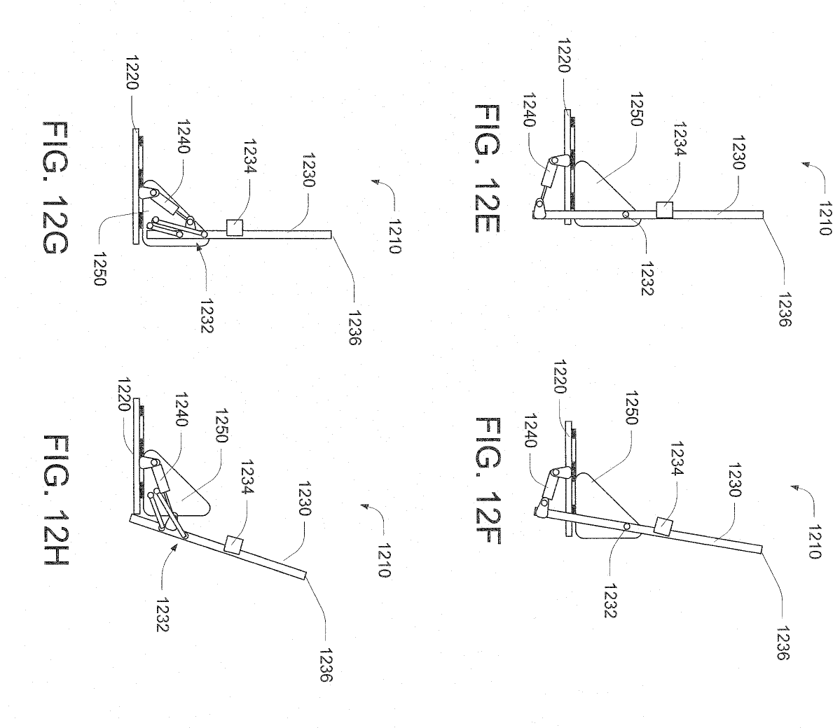

Referring to FIG. 12A and FIG. 12B, a hydraulic ram 1240 is pivotally attached above the pivot point 1232 of the post 1230 about the bed 1220. In this example embodiment the post is bent to enable the hydraulic ram 1240 to be located outside the post (relative to the load not shown), such that retraction of the hydraulic cylinder moves the stabilisers between a substantially vertical transport position (as best shown in FIG. 12A) and an open or loading position (as best shown in FIG. 12B).

Referring to FIG. 12C and FIG. 12D, a hydraulic ram 1240 is pivotally attached below the pivot point 1232 of the post 1230 about the bed 1220. In this example embodiment the post is bent to enable the hydraulic ram 1240 to be located outside the post (relative to the load not shown) such that extension of the hydraulic cylinder moves the stabilisers between a substantially vertical transport position (as best shown in FIG. 12C) and an open or loading position (as best shown in FIG. 12D).

Referring to FIG. 12E and FIG. 12F, a hydraulic ram 1240 is pivotally attached below the pivot point 1232 of the post 1230 about the bed 1220. In this example embodiment the hydraulic ram 1240 to be located insides the post (relative to the load not shown) and below the bed, such that retraction of the hydraulic cylinder moves the stabilisers between a substantially vertical transport position (as best shown in FIG, 12E) and an open or loading position (as best shown in FIG. 12F).

Referring to FIG. 12G and FIG. 12H, the post is pivoted about the bed by a hinge comprising three linkages. This hinge enables the post to move rotationally and translatably in relation to the bed between a substantially vertical transport position (as best shown in FIG. 12G) and an open or loading position (as best shown in FIG. 12H). The hydraulic cylinder 1140 influences the stabilisers to assume a continuity of positions including the open or loading position and the substantially vertical transport position.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprises, comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A trailer for carrying over sized bales, comprising:
a wheel assembly;
a flat bed that pivots about the wheel assembly;
the flat bed comprising a longitudinal conveyor and one or more compression stations for reducing the effective width of a bale;
wherein the one or more compression stations each include a pair of stabilisers located on opposite side edges of the bed;
each compression station adapted to have a compressed orientation wherein a stationary bale on the bed is laterally compressed and an open orientation wherein the bale is not compressed.

2. The trailer of claim 1, wherein:
each compression station comprises a pair of opposing hydraulically activated stabilisers, each stabiliser comprising a rigid post that is pivoted at its lower end with respect to the bed and a hydraulic cylinder affixed between the bed and the stabiliser.

3. The trailer of claim 1, wherein:
a compression station is associated with a pair of orientation bumpers that facilitate a movement of the bales as they are propelled forward by the conveyors.

4. The trailer of claim 1, wherein:
a stabiliser comprises at least one transverse brace, the brace being a rigid member that is affixed to a post.

5. The trailer of claim 2, wherein:
at least one end of the transverse brace is tapered and the hydraulic cylinder is pivotally attached to the stabiliser at a point below the transverse brace,

6. The trailer of claim 1, wherein:
the transport bed comprises a crawler located toward a rear of the bed, usable so as to move an entire vehicle comprising a prime mover and the bed forward and backward;
the conveyor adapted to propel bales forward and onto the bed when loading and able to discharge bales from a rear end when unloading.

7. The trailer of claim 1, further comprising:
a pivoting gate mechanism having an opposing pair of swing arms, each supporting one or more rotating bumpers.

8. The trailer of claim 1, wherein:
the transport bed further comprises a guide skirt, being a flexible polymer sheet that extends along a length of an edge of the bed.

9. The trailer of claim 3, wherein:
the orientation bumpers are located to either side of a stabilizer and set at an angle with respect to the bed.

10. The trailer of claim 1, wherein:
the convey is a chain conveyor that extends fore and aft, extending from one end of the bed to another.

11. The trailer of claim 1, wherein:
the bed pivots under the influence of gravity as the wheel assembly advances toward a set of jack wheels.

12. The trailer of claim 4, wherein:
the transverse brace is welded to an interior surface of a stabilizer's post.

13. The trailer of claim 7, wherein:
the gate further comprises a pair of swing arms, each with vertically mounted rollers that are stagger mounted to conform to the size and shape of a bale carried by the trailer.

14. The trailer of claim 1, wherein:
a compression station further comprises a rotating crank arm to which is attached a rigid upright, the rotation of arm acting to compress a bale in the station.

15. The trailer of claim 1, wherein:
a compression station further comprises two opposing posts and the posts cooperate to compress a bale;
an upper end of each post in a compression station being attached by a hydraulic ram to move the posts from a loading position to a compressed position.

16. The trailer of claim 1, wherein:
a compression station further comprises two opposing posts and the posts cooperate to compress a bale;
an upper end of each post in a compression station being attached by a retractable cable to move the posts form a loading position to a compressed position.

17. A trailer for carrying over sized bales, comprising:
a wheel assembly;
a flat bed that pivots about the wheel assembly;
the flat bed comprising a longitudinal conveyor and one or more compression stations for reducing the effective width of a bale;
wherein the one or more compression stations each include a pair of stabilisers located on opposite side edges of the bed;
each compression station adapted to have a compressed orientation wherein a stationary bale on the bed is laterally compressed to a roadable width and an open orientation wherein the bale is not compressed;
each compression station comprising a pair of opposing stabilisers, each stabiliser comprising a rigid post that is pivoted at its lower end with respect to the bed; and
a gate.

18. The trailer of claim 17, wherein:
a compression station further comprises a hydraulic rotating crank arm to which is attached a rigid upright, the rotation of arm acting to compress a bale in the station.

19. The trailer of claim 17, wherein:
a compression station further comprises two opposing posts and the posts cooperate to compress a bale;
an upper end of the opposing posts in a compression station being attached by a hydraulic ram that moves the posts form a loading position to a compressed position.

20. The trailer of claim 17, wherein:
a compression station further comprises two opposing posts and the posts cooperate to compress a bale;
an upper end of each post in a compression station being attached by a retractable cable that moves the posts form a loading position to a compressed position.
